(19) United States
(12) Patent Application Publication
(10) Pub. No.: US 2013/0145805 A1
(43) Pub. Date: Jun. 13, 2013

(54) SOIL IMPROVER

(71) Applicants: Francis Lynn (Gus) OLSON, Rancho Mirage, CA (US); Rene de Santiago PALOMARES, Tucson, AZ (US)

(72) Inventors: Francis Lynn (Gus) OLSON, Rancho Mirage, CA (US); Rene de Santiago PALOMARES, Tucson, AZ (US)

(73) Assignee: WISEARTH IP, INC., Irving, TX (US)

(21) Appl. No.: 13/617,243

(22) Filed: Sep. 14, 2012

Related U.S. Application Data
(63) Continuation-in-part of application No. 61/534,478, filed on Sep. 14, 2011.
Application No. 61/534,478 is a continuation-in-part of application No. 61/593,961, filed on Feb. 2, 2012.

(51) Int. Cl. C05F 11/08

(52) U.S. Cl. CPC C05F 11/08
USPC 71/6

(57) ABSTRACT

A soil improver and method for making the same. The soil improver, in one example, comprises a nitrogen source, a surfactant, a multi-mineral, and a microbial blend. The microbial blend comprises at least one bacterium, at least one fungus, and at least one mycorrhiza. The mycorrhizae mine water and nutrients for plant roots in exchange for food. Further the mycorrhizae greatly expands the effective root zone of the host plant. The soil improver is made by mixing the dry ingredients. Thereafter the microbial blend is mixed with the dry ingredients.

### CROSS-REFERENCE TO RELATED APPLICATION

This application is a continuation-in-part of co-pending U.S. Provisional Patent Application Ser. No. 61/534,478, entitled “Organic Soil Improver,” filed Sep. 14, 2011, the technical disclosure of which is hereby incorporated herein by reference. This application is also a continuation-in-part of co-pending U.S. Provisional Patent Application Ser. No. 61/593,961, entitled “Organic Soil Improver,” filed Feb. 2, 2012, the technical disclosure of which is hereby incorporated herein by reference.

### BACKGROUND OF THE INVENTION

1. Technical Field

The present invention relates to a soil improver comprising microbes and method for making the same.

2. Description of Related Art

As crops are grown, especially after repeated planting cycles, the quantity of the available nutrients in the soil which are necessary to grow the crops becomes depleted. Nutrient fertilizers are applied to soil in which crops and ornamentals are grown to replace these depleted nutrients.

Often farmers overuse fertilizers. This results in damage to microbes, fungi, nutrients, and other elements of the soil. Therefore, a need exists to replenish the nutrients, microbes, and/or fungi which have been previously decimated.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a process flow chart of a method for making a soil improver in one embodiment.

FIG. 2 is a perspective view of an applicator in one embodiment.

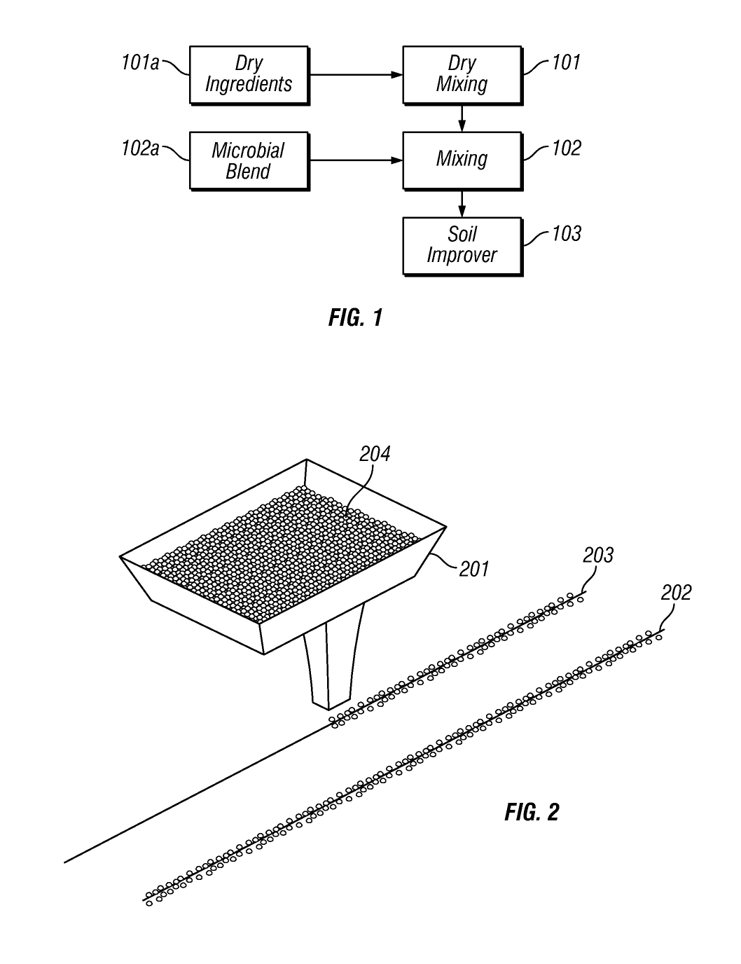

### DETAILED DESCRIPTION

Several embodiments of Applicants' invention will now be described with reference to the drawings. Unless otherwise noted, like elements will be identified by identical numbers throughout all figures. The invention illustratively disclosed herein suitably may be practiced in the absence of any element which is not specifically disclosed herein.

The term “organic” includes materials having a molecular skeleton comprising a carbon backbone, for example compositions derived from living matter. The term “organic” also comprises materials which are “verified organic.” As used herein, the term “verified organic” refers to crops or materials which meet or exceed the standards of the National Organic Program as set forth by the United States Department of Agriculture. In one embodiment, the term “verified organic” also encompasses ingredients which are not manufactured or mined at approved locations but are otherwise eligible for “verified organic” status. In one embodiment the term “organic” also encompasses mined materials. For example, soft rock phosphate is a mined material, not derived from organic manner, but allowable for use in organic agriculture and is capable of being “verified organic.” Such items are deemed to be organic. Generally, inorganic fertilizers are manufactured from non-living materials, and include, for example, ammonium nitrate, ammonium sulfate, urea, ammonium phosphate, potassium chloride, etc. Inorganic fertilizers are readily available and are generally inexpensive but have a number of disadvantages.

A fertilizer is a product which adds nutrients to the soil. A soil improver, by contrast, improves the physical, chemical, biochemical, and/or biological or other characteristics of the soil. A soil improver is a broad description which can include fertilizers. In one embodiment the soil improver comprises a microbial blend. A microbial blend comprises at least one bacterium, at least one mycorrhiza, and at least one non-mycorrhiza fungus. As those skilled in the art will understand, all mycorrhiza are classified as fungi. Thus, the microbial blend comprises at least one mycorrhiza and one non-mycorrhiza fungus. These ingredients will be discussed in more detail below.

Microbes are essential in plants as they break down nutrients into a size and form which are absorbable by the plants. Therefore, without microbes, even if sufficient nutrients are available, the plant is unable to absorb the necessary nutrients. Instead, the plants will absorb only those ions which happen to hit the plant's root.

In one embodiment the soil improver is organic. In another embodiment the soil improver is verified organic, while in still other embodiments the soil improver is inorganic. Table 1 below illustrates the formulation of the dry ingredients to a soil improver in one embodiment. As depicted the formulation includes a surfactant, a microbial growth nutrient, a multi-mineral, a nitrogen source, and a microbial blend. Each of these will be discussed in more detail below. Other embodiments comprise formulations which have one or more of the above listed ingredients missing, while still other embodiments comprise additional ingredients. For example, in one embodiment the formulation does not comprise a microbial blend, whereas in other embodiments the formulation comprises a metabolizer.

| | Range | Sample Embodiment |
|---|---|---|
| Ingredient | Weight % | (Weight %) |
| Surfactant | 2-7 | 3 (Yucca powder) |
| Chelator | 0-10 | 4 (Humic acid powder) |
| Chelator | 2-8 | 2 (Soluble Fulvic Acid or low |
| | | pH Humic Acid) |
| Microbial growth | 1-10 | 5 (Seaweed powder) |
| nutrient | | |
| Multi-mineral | 25-70 | 70% (Azomite) |
| Nitrogen source | 5-25 | 11% (Feather meal, fish emulsion) |
| Microbial Blend | 5-25 | 6% |

As noted, the soil improver comprises a surfactant. A surfactant helps speed the delivery of the soil improver into the soil by reducing the surface tension between particles, thereby allowing more rapid and thorough penetration of the product into the soil. Thus, a surfactant helps with distribution. The surfactant, in one embodiment, also acts as a penetrant which helps penetrate root walls, cell walls, seed walls, etc. Often a penetrant is desirable to aid in the delivery. Finally, in one embodiment the surfactant serves as a micronutrient source for the fungi in the product. Enhanced micronutrient availability increases the microbial population growth.

As noted above, in one embodiment the surfactant comprises a yucca powder. Yucca powder comprises saponin, which is a natural wetting agents, among other components.

The surfactant can be in many forms, including a powder. This typically helps with long term release. In other embodiments the surfactant is in the form of a spray dried crystal. Such embodiments are utilized for more immediate release applications. In still other embodiments a combination of long term and immediate release applications are utilized. The amount of surfactant can vary. In one embodiment the surfactant comprises between about 1% and about 6% of the final formulation. Surfactants, such as yucca, can also stimulate microbial growth. As noted, the surfactant can comprise a variety of ingredients. In one embodiment, the surfactant comprises on or more of the following: organic surfactants such as quillaja, soapberry, seaweed, lignin sultanate, and inorganic surfactants such as linar alkylbenzenesulfonates, alkylphenol ethoxylates, fatty alcohol ethoxylates, 2,6,8-Trimethyl-4-nonyl ether ethoxylate (6EO), Alcohol ethoxylates, Alkyl polyglucosides, Alkylphenol ethoxylates, Ammonium dodecyl benzene sulfonate, Ammonium nonylphenol ethoxylate sulfate, Azo lignosulfonate, Calcium alkylbenzene sulfonate, Calcium lignosulfonate, Casein, Castor oil ethoxylate, Cocamidopropyl betaine, Ethoxylated Sorbitan Laurate, Lecithin, Nonoxynol-9 phosphate, Polyethylene glycol monooleate, Polyoxyethylene stearate, Saponins, Sodium alkyl naphthalene sulfonate, formaldehyde polymer, Sodium alpha olefin sulfonate, Sodium dioctyl sulfosuccinate, Sodium dodecylbenzene sulfonate, Sodium lauryl ether sulfate, Sodium lignosulfonate, Sodium N-methyl-N-oleyl taurate, Sodium nonylphenol phosphate ethoxylate, Sodium octylaminopropionate, Sodium oxyligninsulfonate, Sorbitan monooleate, Tridecyl alcohol ethoxylate, and/or Tristyrylphenol ethoxylate.

As noted above, in one embodiment the formulation comprises a chelator. The chelator can comprise many different ingredients such as humic acid, fulvic acid, amino acids, low pH humic acid, ethylenediaminetetraacetic acid, and mixtures thereof. In one embodiment, the humic acid can be derived from Leonardite. In one embodiment the chelator acts as a binder and comprises lignin sulfonate, some examples of which include calcium lignosulfonate, sodium lignosulfonate, sodium oxyligninsulfonate, ammonium lignosulfonate, azo lignosulfonate, and combinations thereof. In one embodiment the chelator comprises BorrePlex CA Powder produced by Borregaard Ligno Tech of Rothschild, Wis. BorrePlex CA is a calcium lignosulfonate based product. This chelator is deemed organic, and in some cases, is deemed verified organic. The amount of the chelator can vary from between about 0 to about 25% of the formulation, whereas in other embodiments the chelator accounts for about 10% of the formulation. The humic acid or other chelator stimulates the plant into being ready to absorb nutrients, and in one embodiment the humic acid is water soluble. In one embodiment, the chelator acts as a micronutrient source for the microbes.

Further, as noted above, in one embodiment the formulation also comprises a microbial growth nutrient which can serve as a micronutrient source for the microbes. The microbial growth nutrient can comprise multi-minerals which are utilized by the microbes. The multi-minerals serve two specific purposes. First, the microbes themselves need minerals to grow, perform physiological functions, and reproduce. Second, the microbes can process these minerals in such a way as to make them available to the plant. The multi-minerals can contain many micro-nutrients in mineral form. In one embodiment, a wide variety of micro nutrients and minerals as possible are provided in order to prevent any yield limitations. In one embodiment the microbial growth nutrient comprises between about 1% to about 10% of the formulation.

In one embodiment the microbial growth nutrient comprises seaweed and/or seaweed powder. The natural properties of the seaweed can be extracted using a low heat processing system, which preserves the maximum benefits of the live seaweed. The seaweed provides minerals, vitamins, and nutrients which can be used by both the microbes and, ultimately, the plant. Other growth nutrients can also be utilized including virtually any protein source such as crab, soybean, molasses, milk solids, egg protein, blood, feather meal, blood meal, fish, etc. Further, organic acids such as amino, humic, and fulvic can also be utilized.

As noted in one embodiment the formulation further comprises a metabolizer. In one embodiment the metabolizer comprises multi-chelated amino acid. There are several acceptable metabolizers including biomin calcium. A metabolizer provides building blocks necessary for microbe growth. The metabolizer can also comprise virtually any organic acid and multi-minerals. The metabolizer, in one embodiment, comprises about 0-5% of the formulation.

The formulation, in one embodiment, further comprises a multi-mineral. The multi-mineral can take many forms, but in one embodiment the multi-mineral comprises Azomite, which is a volcanic ash. AZOMITE®, sold by Azomite of Nepli, Utah, is a mined natural mineral product that is an excellent anti-caking agent and a unique re-mineralizer for soils. Assays reveal that the material contains a broad spectrum of over 70 active minerals and trace elements. The multi-mineral can supply nutrition for both the plants and the microbes. Further, it provides clays which house microbes. In one embodiment the multi-mineral comprises the bulk of the formulation representing from between about 25% to about 70% of the formulation. The multi-mineral can also comprise Elemite manufactured by Wasatch Minerals of Lehi, Utah. The multi-mineral can also comprise any volcanic ash, bentonite, montmorillonite, and others.

As noted, in one embodiment the formulation comprises a nitrogen source. The nitrogen source can comprise a slow release nitrogen source or an immediate release nitrogen source and combinations thereof. A slow release nitrogen source is a source which is still releasing nitrogen and which has at least 50% of available nitrogen remaining after three months during normal soil temperatures and conditions. The slow release nitrogen source can comprise a single ingredient or it can comprise multiple ingredients. In one embodiment the slow release nitrogen source comprises blood meal and/or feather meal. The blood meal can comprise blood from a variety of animals, but in one embodiment the blood meal comprises poultry blood meal. As used herein blood meal refers to clean fresh blood from an animal exclusive of feathers, hide or skin except in such traces which might occur unavoidably in good manufacturing practices. In one embodiment the poultry blood meal comprises about at least 85% protein, about 3.5 to about 8% moisture, and less than about 1% fat.

In one embodiment the blood meal is in a powder form. In one embodiment the blood meal is still releasing nitrogen two weeks after application.

In one embodiment the nitrogen source comprises feather meal. Feather meal refers to hydrolyzed clean feathers of poultry exclusive of blood except in traces which might occur unavoidably in good manufacturing practices. In one embodiment the feather meal comprises about at least 80% protein, about 3.5 to about 8% moisture, and between about 8-10% fat. In one embodiment the feather meal is ground to form a powder.

In one embodiment, the feather meal is still releasing nitrogen six weeks after the application. Other nitrogen sources include blood meal, bat guano, chicken manure, dairy cow manure, steer manure, hog manure, dried milk, whey powder, etc.

In one embodiment the formulation also comprises a more immediate nitrogen source. An immediate source is a source in which the majority of the nitrogen is released within one month after application under normal soil temperatures and conditions. An immediate nitrogen source can comprise some nitrogen which is slowly released, but the bulk of the nitrogen in the immediate nitrogen release is released within one month. Thus, a slow nitrogen source may contain both slow release and immediately available nitrogen. For example, blood meal is generally a slow nitrogen source but it may comprise some nitrogen which is more immediately available. Allowing some nitrogen to be absorbed immediately provides flexibility. For example, some plants may require an immediate source of nitrogen but will then not require additional nitrogen until later on in the plant cycle. Being able to control the amount of nitrogen available over time allows the available nitrogen to better mimic the required nitrogen over time. The nitrogen source also acts as a micronutrient source for microbes.

In one embodiment the nitrogen source comprises fish emulsion powder. A fish emulsion powder is manufactured by mixing fish carcasses with an organic enzyme. In one embodiment organic fish protein which has been spray dried and hydrolyzed is utilized. The fish emulsion powder is typically ground and dried before being packaged. Thus, in one embodiment the fish emulsion powder comprises a powder form. In one embodiment the fish emulsion powder is 100% soluble in water. This is beneficial in that it helps in the delivery of nutrients to the plant following application. Furthermore, fish emulsion is high in Nitrogen and is generally more readily available than many other nitrogen sources.

In one embodiment the fish emulsion powder comprises at least about 11% nitrogen. In one embodiment the fish emulsion powder comprises at least about 0.25% P₂O₅, whereas in another embodiment the fish emulsion powder comprises at least about 1% K₂O. Accordingly, when used, the fish emulsion powder also provides a source of potassium and phosphorus. As noted, both of these are required by the plant. In one embodiment at least a portion of the potassium and phosphorus in the fish emulsion powder is immediately available for release.

In one embodiment the soil improver comprises only a single nitrogen source. In one embodiment it does not matter whether the source is a slow release or immediate release as the nitrogen is released quickly. Without being limited to theory, Applicants believe that in some embodiments the nitrogen degrades more quickly because of the presence of the microbes. Accordingly, in some embodiments virtually any nitrogen source disclosed herein can be utilized. The nitrogen source provides immediate food for the microbes.

Finally, as noted, in some embodiments, the formulation comprises a microbial blend. The microbial blend can comprise between about 0% and about 25% of the formulation. Different microbes can be used for different plants. Some microbes are beneficial to virtually all plants. Many are nutrient cyclers that enhance the uptake of minerals for the plant. Additionally, many produce plant growth, enzymes, vitamins, etc. and help protect the plant from disease and nematodes.

As noted, the microbial blend comprises at least one bacterium and at least one non-mycorrhiza fungus. In one embodiment these are selected to perform specific duties in the plant's root zone. In one embodiment the bacterium and fungus aid in nutrient cycling which benefits the plant by supplying nutrients in forms that the plant can use. In another embodiment they aid in reducing the impact of pathogens, whereas in another embodiment they are predators of pathogens. While at least one non-mycorrhiza fungus and at least one bacterium are utilized, in one embodiment a plurality of different non-mycorrhiza fungi and bacteria are utilized. Thus, as noted above, some bacteria and fungi are selected to aid in nutrient cycling whereas some bacteria and fungi are selected to impact pathogens. The exact combination of fungi and bacteria utilized will depend upon a variety of factors including the type of plant, the type of soil, climate, surrounding plants, etc.

The microbial blend further comprises at least one mycorrhiza but may comprise two or more mycorrhizae. As noted above, a mycorrhiza is a specialized fungi which mines water and nutrients for plant roots in exchange for food. Mycorrhizae and microbe populations have been decimated due to overuse of inorganic fertilizers, pesticides, fungicides, and herbicides along with over tillage, and soil compaction. By introducing additional mycorrhizae and/or microbes back into the plant population, the plant is made to be much more effective in absorbing nutrients and water from the soil. Essentially, increasing the mycorrhizae concentration expands the effective root zones of a plant many times over. One reason the mycorrhizae is beneficial is that the mycorrhizae are capable of extending far out into the soil to bring back nutrients and water that the plant's roots cannot reach. The size of the mycorrhizae's filaments, in one embodiment, are so small that it can reach into spaces that plant roots are too large to reach.

It should be noted that addition of mycorrhizae without the additional addition of bacteria can often cause the mycorrhizae to become parasitic, and thus, detrimental to the plant. Accordingly, the addition of mycorrhizae by itself, does not offer the same benefits as the combination of at least one bacterium, at least one non-mycorrhiza, and at least one mycorrhiza.

Mycorrhizae can be further broken down into endo mycorrhizae and ecto mycorrhizae. The soil improver can comprise endo mycorrhizae and/or ecto mycorrhizae and combinations thereof. Endo mycorrhizae penetrate the plant roots whereas ecto mycorrhizae do not. Further, ecto mycorrhizae are often utilized for trees whereas endo mycorrhizae are more generalized to a variety of plants.

In one embodiment the mycorrhizae comprises an arbuscular mycorrhizae (AM) whereas in another embodiment the mycorrhizae comprises a vesicular-arbuscular mycorrhizae (VAM). An embodiment comprising AM will be discussed but such discussion should not be deemed limiting. The AM helps the plant capture nutrients from the soil such as phosphorus, nitrogen, as well as micronutrients. AM utilizes a symbiotic relationship with the host plant whereby the AM relies upon the host plant for food whereas the host plant relies upon the AM to break down and deliver nutrients. The AM greatly expands the effective root zone of the host plant. In some embodiments the AM doubles or triples the effective root zone.

There are many different types of AM which can be utilized. The type selected will depend upon the type of plant utilized and other such factors.

There are many different microbial blends which can be utilized. In one embodiment a microbial blend of MycoApply Ultrafine Endo from Mycorrhizal Applications of Grants Pass, Oreg.

As noted above, varying mycorrhizae can be utilized. There are approximately 80 known mycorrhizae and virtually any combination may be suitably used. For example, one soil improver utilizes various combinations of the following mycorrhizae: glomus intraradices, Glomus aggregatum, glomus etunicatum, glomus mosseae. It should be noted that this combination has provides a broad spectrum of microbes applicable to a majority of high value crops. The specific combination will depend upon the plant, soil type, value of crop, etc. As an example, the previously described combination for high value crops may be prohibitively expensive for a wheat grower. In such an embodiment other mycorrhizae may be suitably utilized.

In still other embodiments a microbial blend is not utilized. In such embodiments, the soil improver enhances the growth of existing soil microbial populations but does not supplement the microbial populations. Those skilled in the art will be able to evaluate an existing population to determine if the microbes simply need to be fed or if additional microbes should be added. The ingredients discussed herein can be mixed without the microbial blend to result in a blend which does not comprise additional microbes. Further, embodiments which do not comprise a microbial blend can be applied simultaneously with or after application of a soil improver which comprises a microbial blend.

Now that the ingredients have been discussed, a method for manufacturing will now be addressed. There are a variety of ways to manufacture the formulation. Microbes often awaken at about 5% moisture. Consequently, in one embodiment the formulation is manufactured so that the moisture content is maintained below 5% before and during the addition of the microbial blend.

In one embodiment the first step is mixing a nitrogen source, a surfactant, a multi-mineral to form a dry mixture. As noted, further ingredients such as a chelator, a microbial growth nutrient, and multi-chelated amino acids can also be mixed in the dry blend. In this step the dry ingredients 101a are mixed together to form a dry mixture. In one embodiment all ingredients comprise a dry powder. During the dry mixing step 101, all of the dry ingredients 101a can be placed into a batch at once or individual ingredients can be separately added and mixed. In one embodiment each ingredient is added individually and allowed to agitate for about 5 minutes before the addition of an additional ingredient. Thus, for example, a nitrogen source will be mixed with a multi-mineral for a short time before adding a surfactant. In one embodiment any ingredient that is above 5% moisture is mixed with an ingredient which is dry enough and is of sufficient quantity to absorb the excess moisture. Otherwise, undesirable clumping can occur. The ingredients can be mixed with any mixing devices known in the art. As noted, in one embodiment the dry mixture comprises a moisture content less than 5%.

Thereafter, a microbial blend 102a is mixed with the dry blend to form the final soil improver 103. In one embodiment the microbial blend 102a is added to the mixer comprising the dry mixture whereas in other embodiments the microbial blend and the dry mixture are added in a separate mixer and mixed. The mixing process can be batch or continuous. Virtually any mixing equipment can be used during the second mixing step.

In one embodiment the mixing of the microbial blend is conducted at less than 120° F., although in other embodiments the mixing is conducted at less than about 100° F. Some microbes can be damaged at elevated temperatures, therefore, avoiding elevated temperatures helps avoid microbial damage in some embodiments.

The final soil improver in one embodiment is a granular product. The finished product, in one embodiment, has an angle of repose not less than 30 degrees.

In another embodiment, the microbials are mixed first for a period of time, and then the remaining ingredients are added and mixed for a period of time. For example, in one embodiment the microbials are mixed first for 6 minutes, and then the remaining ingredients are added and mixed for 15 minutes.

There are a variety of methods for applying the soil improver. In one embodiment the soil improver is applied down the seed line. This allows the soil improver to be applied directly where it is needed most. For example, the soil improver can be applied directly to the stem of the plant. FIG. 2 is a perspective view of an applicator in one embodiment. As depicted the applicator 201 is applying the soil improver 204 along two seed lines 202, 203. Thus, as depicted seeds have been planted along the seed lines 202, 203. Using an applicator, a user can accurately apply the soil improver along the seed lines 202, 203. This allows nutrients to be absorbed and delivered directly to the plant, seed, and/or soil. Further, this allows the microbial blend to be applied close to the plant. Additionally, because the soil improver can be delivered accurately, the desired amount of soil improver can be utilized by the plant. Consequently, only the necessary amount of soil improver is used. This is beneficial in that less soil improver is wasted which makes the disclosed soil improver and method more economical. In one embodiment the soil improver is applied along a seed zone. In one embodiment the seed zone comprises land which is about 2 inches below, and about 2 inches on both sides of the seed line 202, 203. Accordingly, the microbes and nutrients are concentrated in a small band of land as opposed to spreading all over. This allows the concentration of the microbes in a zone which is more accessible to the plant, which increases the effectiveness of the microbes.

In one embodiment the soil improver is applied in a transplant hole. This allows the soil improver to be applied directly where it is needed most. For example, the soil improver can be applied directly in the planting hole. This allows nutrients to be absorbed and delivered directly to the plant, seed, and/or soil. Further, this allows the microbial blend to be applied in close proximity to the plant. Existing plants can be “side dressed” by injecting the soil improver using a dry fertilizer applicator knife into the soil near the plant roots.

In one embodiment the soil improver is applied on annual crops once per year. Additional soil improver can be applied at planting, after planting, after harvesting, etc. Essentially the soil improver can be applied at any time during the life of the plant.

In another embodiment the soil improver comprises a wettable powder. In such a wettable powder a user will add fluid to suspend the powder for application. The liquid soil improver can be applied by spraying or injecting. Further the liquid soil improver can be used as a seed or plant dip whereby seeds or plants are dipped in the liquid solution prior to planting. This allows delivery of the nutrients and microbes directly to the seed or plant. This allows for increased efficiency as the nutrients and microbes are applied directly on the seed or plant.

The wettable powder can be made in the same method previously discussed herein. In one embodiment fish emulsion is used as a nitrogen source or other micronutrient source. Further, in the wettable powder the amount of multi-mineral is reduced compared to a granular form of the soil improver.

While an embodiment has been discussed wherein the soil improver is applied in a solid form, herein after referred to as a dry state, in other embodiments the soil improver is applied in a wet state. In such an embodiment the solid soil improver is put into a suspension and applied under pressure as a slurry. In one embodiment the solid soil improver is dissolved into a solution and applied. In one embodiment the solution is water. The soil improver can be applied via drip, sprinkler, food or furrow irrigation. It can also be missed with anti-foaming agents to reduce foaming. For example, in one embodiment the soil improver is mixed with corn oil to reduce foaming.

The soil improver, when applied in a wet state, can comprise the same ingredients discussed above herein. In one embodiment the wet form comprises different ratios of the same ingredients compared to the soil improver in a dry state. In still other embodiments the wet state comprises fewer or more ingredients than the dry state. In still other embodiments, the ingredients in table 2 may also be utilized in the dry stage. Table 2, below, illustrates ingredient ranges for the soil improver in a wet state in one embodiment.

| | Range | Sample Embodiment |
|---|---|---|
| Ingredient | Weight % | (Weight %) |
| Surfactant | 2-7 | 2 (Yucca) |
| Chelator | 1-30% | 24 (Humic Acid) |
| Chelator | 0-20% | 14 (Soluble fulvic acid or low |
| | | pH Humic Acid) |
| Microbial growth | 1-30% | 21 (Seaweed powder) |
| nutrient | | |
| Multi-mineral | 25-70% | 33 (Azomite) |
| Nitrogen source | 0-10% | 8 (powdered fish emulsion, blood |
| | | meal, and/or feather meal) |
| Microbial Blend | 5-25% | 10 |
| Chelator | 0-10% | 6 (Borreplex) |

While the invention has been particularly shown and described with reference to a preferred embodiment, it will be understood by those skilled in the art that various changes in form and detail may be made therein without departing from the spirit and scope of the invention.

### ADDITIONAL DESCRIPTION

The following clauses are offered as further description of the disclosed invention.
1. A soil improver comprising:

a nitrogen source;

a surfactant;

a multi-mineral;

a microbial blend, wherein said microbial blend comprises:
at least one bacterium;
at least one fungus;
at least one mycorrhiza.
2. The soil improver according to any preceding clause further comprising:

a chelator;

a microbial growth nutrient; and

a multi-chelated amino acid.
3. The soil improver according to any preceding clause wherein said surfactant comprises yucca.
4. The soil improver according to clause 2 wherein said chelator comprises humic acid.
5. The soil improver according to clause 2 wherein said nitrogen source comprises feather meal.
6. The soil improver according to clause 2 wherein said microbial growth nutrient comprises sea weed.
7. The soil improver according to clause 2 wherein said multi-mineral comprises ash.
8. The soil improver according to clause 2 wherein said soil improver comprises between about 5 to about 25% nitrogen, between 1 and about 10% chelator, between 1 and about 10% microbial growth nutrient, between about 40 and about 70% multi-mineral, and between about 5 and 25% microbial blend.
9. A method for a soil improver, said method comprising:

a) mixing a nitrogen source, a surfactant, a multi-mineral to form a dry mixture;

b) mixing a microbial blend, wherein said microbial blend comprises:
at least one bacterium;
at least one non-mycorrhizae fungus;
at least one mycorrhizae.
10. The method according to clause 9 wherein said mixing of step a) further comprises mixing a chelator, a microbial growth nutrient, and a multi-chelated amino acid.
11. The method according to clauses 9-10 wherein said mixing of step a) comprises maintaining the moisture content of said dry mixture below 5%.
12. The method according to clauses 9-11 wherein said mixing of step b) is conducted below 100° F.
13. The method according to clauses 9-12 wherein said mixing of step a) comprises adding each ingredient separately.
14. A method for a soil improver, said method comprising:

a) mixing a microbial blend, wherein said microbial blend comprises:
at least one bacterium;
at least one non-mycorrhizae fungus;
at least one mycorrhizae.

b) mixing a nitrogen source, a surfactant, a multi-mineral to form a mixture.

What is claimed is:

1. A soil improver comprising:
a nitrogen source;
a surfactant;
a multi-mineral;
a microbial blend, wherein said microbial blend comprises:
at least one bacterium;
at least one fungus;
at least one mycorrhiza.

2. The soil improver of claim 1 further comprising:
a chelator;
a microbial growth nutrient; and
a multi-chelated amino acid.

3. The soil improver of claim 1 wherein said surfactant comprises yucca.

4. The soil improver of claim 2 wherein said chelator comprises humic acid.

5. The soil improver of claim 2 wherein said nitrogen source comprises feather meal.

6. The soil improver of claim 2 wherein said microbial growth nutrient comprises sea weed.

7. The soil improver of claim 2 wherein said multi-mineral comprises ash.

8. The soil improver of claim 2 wherein said soil improver comprises between about 5 to about 25% nitrogen, between 1 and about 10% chelator, between 1 and about 10% microbial growth nutrient, between about 40 and about 70% multi-mineral, and between about 5 and 25% microbial blend.

9. A method for a soil improver, said method comprising:
a) mixing a nitrogen source, a surfactant, a multi-mineral to form a dry mixture;
b) mixing a microbial blend, wherein said microbial blend comprises:
at least one bacterium;
at least one non-mycorrhizae fungus;
at least one mycorrhizae.

10. The method of claim 9 wherein said mixing of step a) further comprises mixing a chelator, a microbial growth nutrient, and a multi-chelated amino acid.

11. The method of claim 9 wherein said mixing of step a) comprises maintaining the moisture content of said dry mixture below 5%.

12. The method of claim 9 wherein said mixing of step b) is conducted below 100° F.

13. The method of claim 9 wherein said mixing of step a) comprises adding each ingredient separately.

14. A method for a soil improver, said method comprising:
a) mixing a microbial blend, wherein said microbial blend comprises:
at least one bacterium;
at least one non-mycorrhizae fungus;
at least one mycorrhizae.
b) mixing a nitrogen source, a surfactant, a multi-mineral to form a mixture.
